(19) United States
(12) Patent Application Publication
(10) Pub. No.: US 2019/0163830 A1
(43) Pub. Date: May 30, 2019

(54) CUSTOMER SERVICE ADVOCACY ON SOCIAL NETWORKING SITES USING NATURAL LANGUAGE QUERY RESPONSE FROM SITE-LEVEL SEARCH RESULTS

(71) Applicant: INTERNATIONAL BUSINESS MACHINES CORPORATION, Armonk, NY (US)

(72) Inventor: Lisa Seacat DeLuca, San Francisco, CA (US)

(21) Appl. No.: 15/823,703

(22) Filed: Nov. 28, 2017

(51) Int. Cl. G06F 17/30

(52) U.S. Cl. CPC G06F 17/30867; G06Q 50/01; G06F 17/30905

(57) ABSTRACT

A method, computer system, and computer program product for implementing three-dimensional text input in an augmented reality system are provided. The embodiment may include capturing a first user hand position along a first axis of a three-dimensional virtual space. The embodiment may also include identifying a first character along the first axis corresponding to the first user hand position. The embodiment may further include capturing a second user hand position along a second axis of the three-dimensional virtual space. The embodiment may also include identifying a second character along the second axis corresponding to the second user hand position. The embodiment may further include identifying one or more proposed words beginning, consecutively, with the identified first character and the identified second character using a dictionary database. The embodiment may also include displaying the one or more identified proposed words on a third axis of the three-dimensional virtual space.

### BACKGROUND

The present invention relates, generally, to the field of computing, and more particularly to social media customer service.

Social media may be a computer-related tool that allows users to interact through the exchange of information, such as videos, images, hyperlinks, and text, across the Internet. A social media service, or social networking service, may relate to a platform, such as an instant messaging service, a short messaging service, a blog, a website, or a community, that allows individuals within a social network to interact. Some social media services allow users to post content with a hashtag which allows for easier identification of the posted content by users with similar interests. A hashtag is a metadata tag typically used by a social media service to group related user posts together. Many enterprises utilize social media to engage with customers and potential customers more easily than through traditional means, such as telephone calls to a dedicated customer service line, while enhancing the overall brand of the enterprise.

### SUMMARY

According to one embodiment, a method, computer system, and computer program product for automatically responding to a social media query with a response generated from a site-level corpus are provided. The embodiment may include capturing a query transmitted to a social media stream associated with an enterprise. The embodiment may also include transmitting the query to a site-level search engine associated with the enterprise. The embodiment may further include identifying an appropriate response to the transmitted query based on one or more results from the site-level search engine. The embodiment may also include generating a social media response to the captured query using one or more natural language processing techniques. The embodiment may further include transmitting the generated social media response to the social media stream.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating an real-time social media response process according to at least one embodiment;

FIG. 3 is a functional block diagram of a social media collaboration between an enterprise with a response from a social query using a site level search according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to social media customer service. The following described exemplary embodiments provide a system, method, and program product to, among other things, respond to social media questions with responses generated from a brand's site level corpus of available data. Therefore, the present embodiment has the capacity to improve the technical field of social media customer service by allowing for automatic, real-time response generation of customer queries submitted through social media networks rather than awaiting a representative to manually identify responsive information and draft a social media reply to a customer's inquiry.

As previously described, social media may be a computer-related tool that allows users to interact through the exchange of information, such as videos, images, hyperlinks, and text, across the Internet. A social media service, or social networking service, may relate to a platform, such as an instant messaging service, a short messaging service, a blog, a website, or a community, that allows individuals within a social network to interact. Some social media services allow users to post content with a hashtag which allows for easier identification of the posted content by users with similar interests. A hashtag is a metadata tag typically used by a social media service to group related user posts together.

Many enterprises have embraced social networking as a platform to engage with customers and potential customers to improve customer relations and enhance overall brand awareness and appeal. However, great effort needs to be expended to ensure customer inquiries submitted through social media platforms are responded to in a timely manner or else an enterprise may risk denigrating the established brand. To ensure a brand is maintained on social platforms, many enterprises employ a team of representatives charged with maintaining the enterprise's social presence by responding to and engaging with customers on social media. Despite the importance to the enterprise, many enterprise social media teams comprise very few individuals and may not be capable of quickly responding to all social media inquiries to the enterprise. As such, it may be advantageous to, among other things, implement a system that monitors an enterprise's social media platform for inquiries that may be responded to through querying the enterprise's site level database and generating a natural language response to the customer that may be posted as a reply on a social media platform.

According to one embodiment, an enterprise's social media profile may be monitored in real-time for customer messages (e.g., wall posts, replies, direct messages, or mentions). Natural language processing may be utilized to identify customer questions within the messages that may require a response from the enterprise. The identified customer question may be translated into a natural language query request on the enterprise's site-level corpus of searchable content. The best fit response returned from the search query of the enterprise's site-level corpus may be used to generate a natural language response to the customer message and, subsequently, included in a reply post to the original customer message.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to utilize a site-level corpus to execute queries received to an enterprise's social media profile thereby enabling an automatic, real-time response system for customer social media inquries.

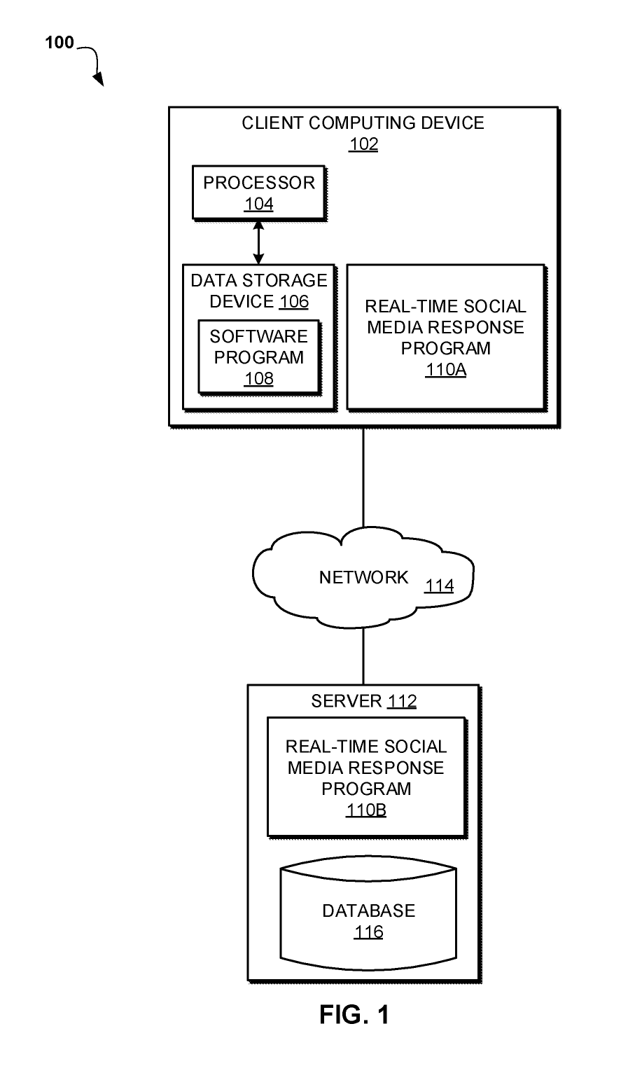

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

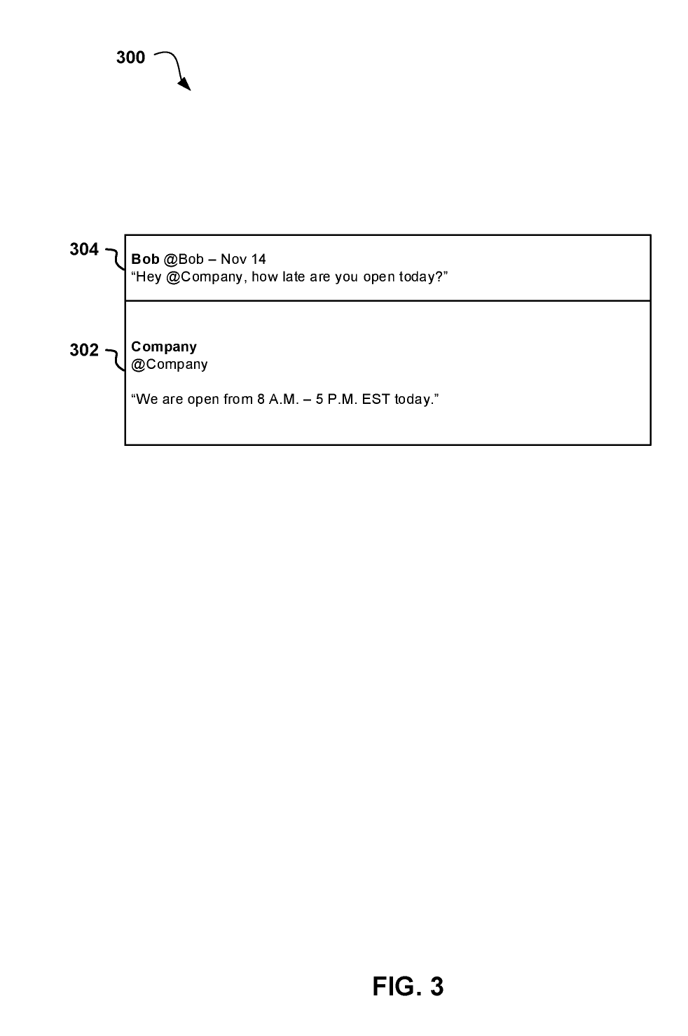

Client computing device 102 may include a processor 104 and a data storage device 106 that is enabled to host and run a software program 108 and a real-time social media response program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running a real-time social media response program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

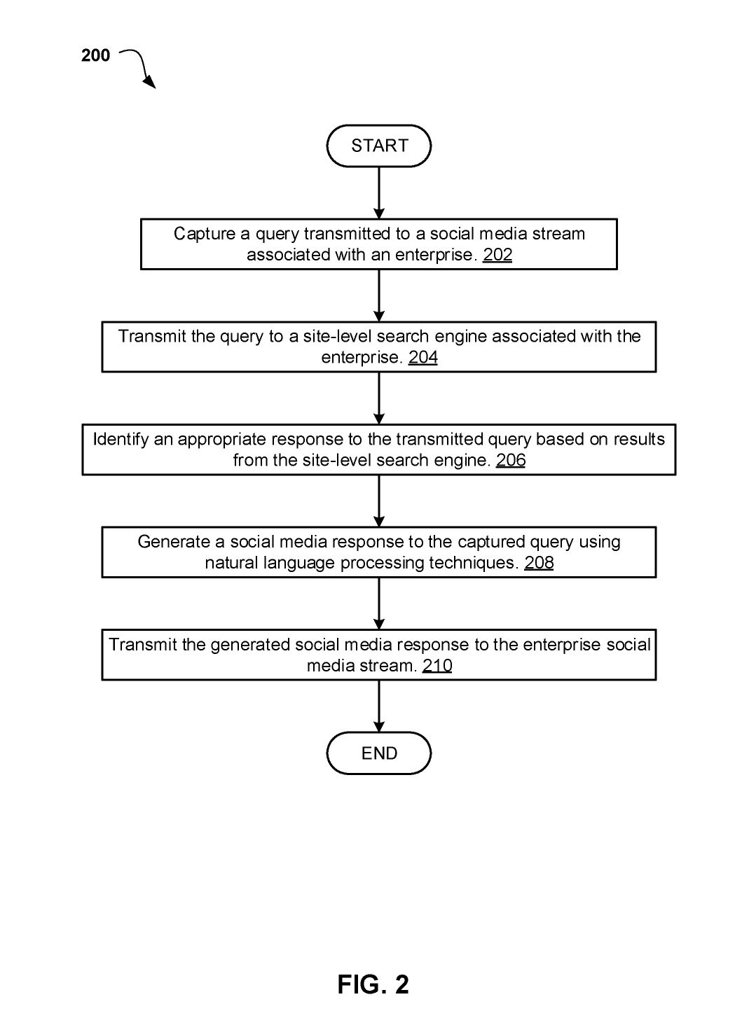

According to the present embodiment, the real-time social media response program 110A, 110B may be a program capable of identifying a customer social media post that may require a response from an enterprise (e.g., asks a question to the enterprise or mentions the enterprise in a post). The real-time social media response program 110A, 110B may query a site-level corpus to identify information responsive to the customer message, and generate a response that may be posted to the social media platform (e.g., a reply to the customer message or a new message string unrelated to the customer message). The real-time social media response method is explained in further detail below with respect to FIG. 2.

FIG. 2 is an operational flowchart illustrating a real-time social media response process 200 according to at least one embodiment. At 202, the real-time social media response program 110A, 110B captures a query transmitted to a social media stream associated with an enterprise. The real-time social media response program 110A, 110B may monitor, in real-time, an enterprise's social media stream for messages posted either by users of the social media platform to the enterprise's profile/page or for posted message that mention the enterprise (e.g., “@” mentions on Twitter® (Twitter and all Twitter-based trademarks and logos are trademarks or registered trademarks of Twitter, Inc. and/or its affiliates). The captured messages may be either publicly visible or private; only viewable by the sender and recipient.

The real-time social media response program 110A, 110B may identify queries within posts to an enterprise's social media stream by implementing natural language processing techniques. Additionally, the query may be a direct question posed to the enterprise. For example, a post on a social media network may be directly sent to an enterprise inquiring what time a local franchise opens for business.

Then, at 204, the real-time social media response program 110A, 110B transmits the query to a site-level search engine associated with the enterprise. When a query is identified, the real-time social media response program 110A, 110B may pass the natural language query text to a site-level search engine associated with the enterprise. In at least one embodiment, the real-time social media response program 110A, 110B may include additional metadata associated with the post to assist the site-level search engine in narrowing the results. For example, in the previous example related to a user inquiring about the particular time a local franchise opens for business, the real-time social media response program 110A, 110B may include metadata related to the user's location, the current date, and the current time so the real-time social media response program 110A, 110B can identify the closest franchise to the user's location and what time the identified franchise opens for business.

Next, at 206, the real-time social media response program 110A, 110B identifies an appropriate response to the transmitted query based on results from the site-level search engine. Using natural language processing and semantic intent, the real-time social media response program 110A, 110B compares the query against the site-level search engine's corpus of data. Semantic intent is a technique utilized to improve the accuracy of search results by analyzing the intent contextual meaning of search terms within a dataspace. When executing the search, the real-time social media response program 110A, 110B may identify an appropriate response based on various response selection criteria, such as the first response returned from the search query or the first response returned with similar semantic intent.

Then, at 208, the real-time social media response program 110A, 110B generates a social media response to the captured query using natural language processing techniques. Once the information relevant to the captured query is identified, the real-time social media response program 110A, 110B may generate a response message to post on behalf of the enterprise to the social media network. When generating the response message, the real-time social media response program 110A, 110B may utilize additional cognitive factors to personalize the message, such as sentiment analysis, semantic intent, tone analysis, and personalized information. Semantic analysis is a technique within natural language processing that enables the understanding of sentiment within a string of text. Accordingly, the real-time social media response program 110A, 110B may utilize semantic analysis to identify the sentiment of a user's original post to an enterprise and generate an appropriate response given that sentiment. For example, if the original user's post posed the question to an enterprise specializing in internet music that asked “What's the best background music for a kickstarter video?”. The real-time social media response program 110A, 110B may determine through a sentiment analyzer, such as IBM Watson® Sentiment Analysis (IBM Watson and all IBM Watson-based trademarks and logos are trademarks or registered trademarks of Twitter, Inc. and/or its affiliates), that the original post was joyful. Therefore, the real-time social media response program 110A, 110B may generate the response of “Keep the joy! Check out this track!” which may be accompanied by a link to the suggested music. Similarly, the same internet music enterprise may receive a user post stating “Worst day ever, I need a pick me up”. Since the real-time social media response program 110A, 110B may determine the text sentiment conveys sadness, the real-time social media response program 110A, 110B may generate the response of “Sorry you are feeling down, maybe this will cheer you up” and accompany a link to an uplifting song.

As previously described, semantic intent relates to techniques utilized to improve the accuracy of search results by analyzing the intent contextual meaning of search terms within a dataspace. The real-time social media response program 110A, 110B may utilize semantic intent when generating a response to identify the user's current state and craft the type of response the user may be looking to receive. For example, the real-time social media response program 110A, 110B may implement semantic intent to determine whether the user is simply researching a product, purchase a product, or whether the user is seeking assistance from a customer service representative.

Similar to sentiment analysis, tone analysis relates to cognitive technology capable of analyzing a text string and identifying the tone of the text. The real-time social media response program 110A, 110B may utilize a tone analyzer, such as IBM Watson® Tone Analyzer, to identify the tone of the user's original message to assist in generating an appropriate response message.

The real-time social media response program 110A, 110B may also utilize personalized information specific to the user to generate a response message based on a user profile retained by the enterprise. For example, if the enterprise is a computer company that previously sold the user a specific desktop computer and the user has sent a message to the enterprise on social media related to a monitor issue, the real-time social media response program 110A, 110B may generate a response that incorporates information about the monitor for the specific model of computer the user purchased from the enterprise.

Next, at 210, the real-time social media response program 110A, 110B transmits the generated social media response to the enterprise social media stream. Once a response is generated, the real-time social media response program 110A, 110B may transmit the generated response as a reply to asking user within the same social media channel. In at least one embodiment, before posting the response, the real-time social media response program 110A, 110B may present the generated response to the enterprise's social media team for approval before posting to the social media stream. The real-time social media response program 110A, 110B may incorporate or include factual evidence with the generated message to provide explanation as to why a proposed response was identified to provide context for the response.

In at least one other embodiment, the real-time social media response program 110A, 110B may calculate a confidence score for each generated response using natural language processing techniques. If the real-time social media response program 110A, 110B determines the calculated confidence score does not satisfy a threshold value, the real-time social media response program 110A, 110B may transmit the generated response to an administrator for review and, if necessary, editing before posting the response to a social media stream. However, if the real-time social media response program 110A, 110B determines the calculated confidence score does satisfy a threshold value, the real-time social media response program 110A, 110B may automatically post the generated response. For example, the real-time social media response program 110A, 110B may determine responses with a 70% confidence score should be reviewed by a social media manager before being posted whereas responses with a 100% score may be posted automatically without any approval necessary.

Referring now to FIG. 3, a functional block diagram of a social media collaboration 300 between an enterprise with a response 302 from a social query 304 using a site level search is depicted, according to at least one embodiment. When a social query 304 is posted to a social network, the real-time social media response program 110A, 110B may query an enterprise's site-level search function to locate information that is responsive to the received social query 304. After using natural language processing techniques to generate a response 302, the real-time social media response program 110A, 110B may post the generated response 302 to the social media network for the original poster of the social query 304 to view in real-time.

It may be appreciated that FIGS. 2 and 3 provide only an illustration of one implementation and do not imply any limitations with regard to how different embodiments may be implemented. Many modifications to the depicted environments may be made based on design and implementation requirements. In at least one embodiment, when the real-time social media response program 110A, 110B identifies two sets of responses are similar, the real-time social media response program 110A, 110B may generate a response for each set of results and present both responses to an administrator for approval on which response is a best fit to the original query.

In at least one other embodiment, the real-time social media response program 110A, 110B may capture and respond to social media posts that relate to an area to which the enterprise may wish to provide more information to ensure brand awareness and integrity. For example, an individual may post a message stating the enterprise was founded in a particular year, however, the enterprise may have been founded in a different year. When the real-time social media response program 110A, 110B determines a message relates to a particular, preconfigured field, the real-time social media response program 110A, 110B may search a repository, such as database 116, to identify the veracity of the information within the post and, if necessary, post a reply message that corrects the misinformation in the original post.

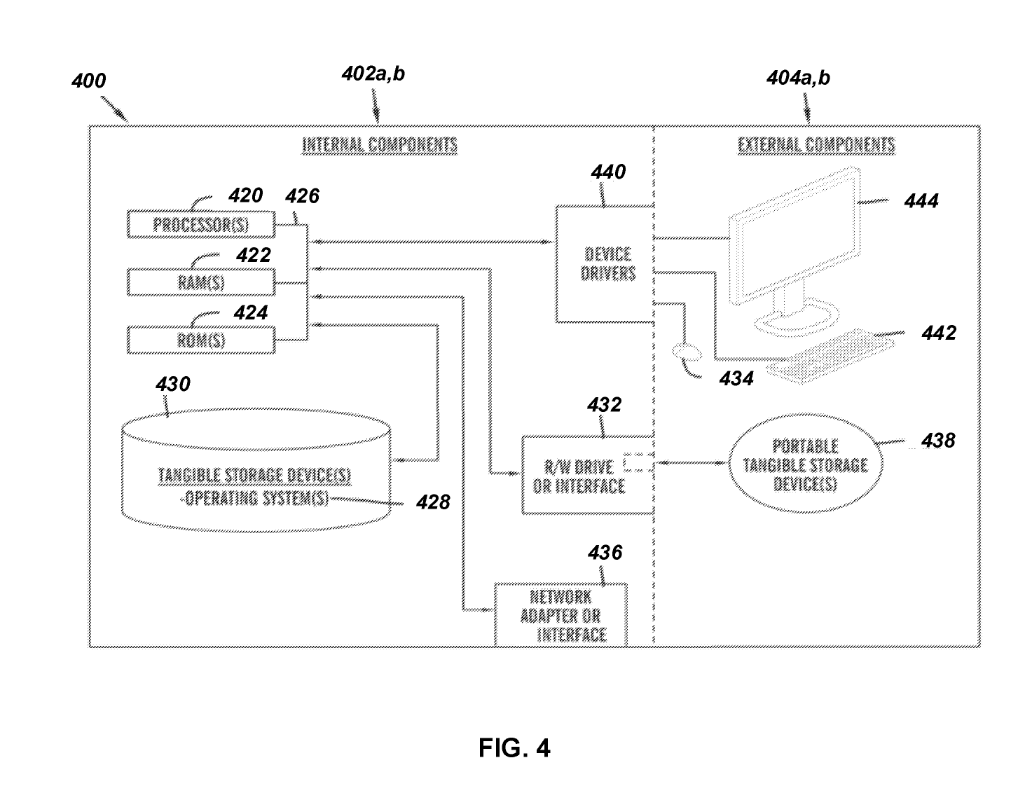

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the real-time social media response program 110A in the client computing device 102 and the real-time social media response program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 338 such as a CD-ROM, DVD, memory stick, magnetic tape, magnetic disk, optical disk or semiconductor storage device. A software program, such as the real-time social media response program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the real-time social media response program 110A in the client computing device 102 and the real-time social media response program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the real-time social media response program 110A in the client computing device 102 and the real-time social media response program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

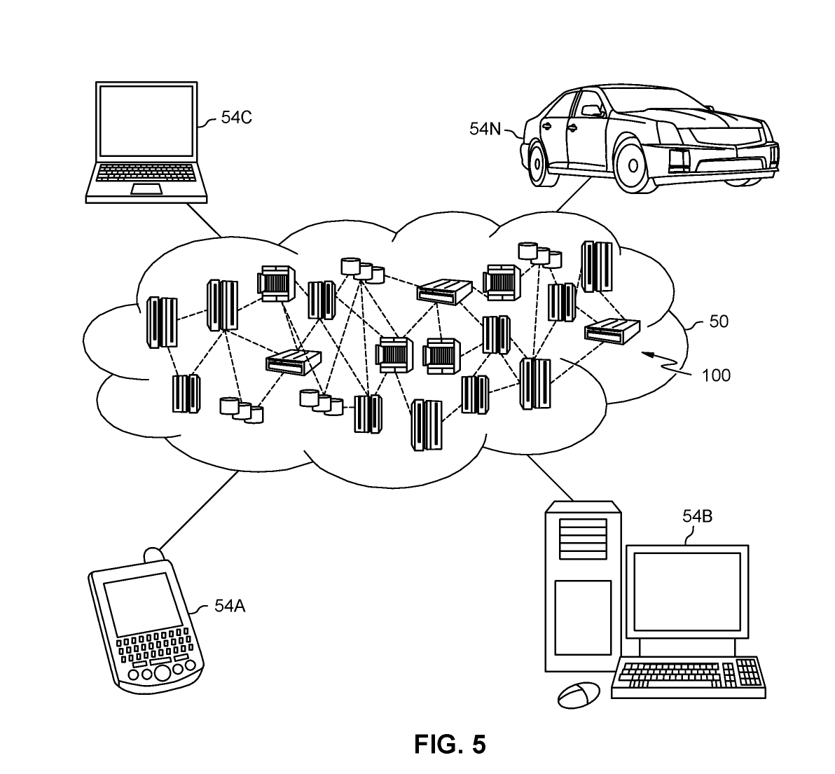

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

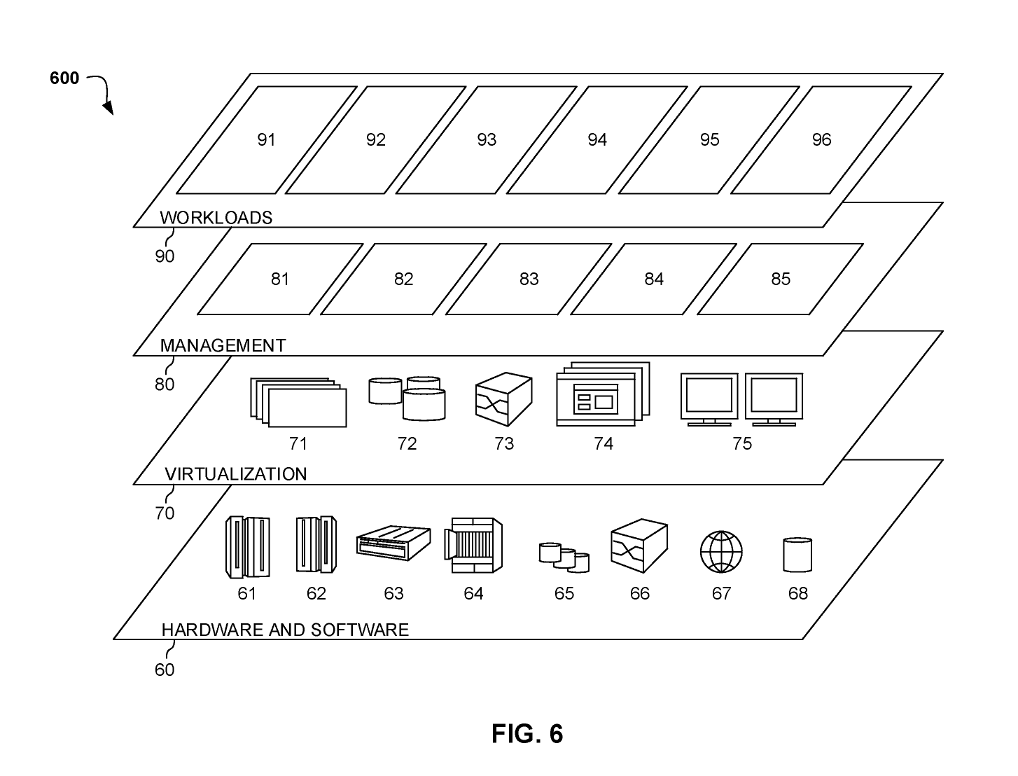

Referring now to FIG. 6, a set of functional abstraction layers 600 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and real-time social media response 96. Real-time social media response 96 may relate identifying customer posts on a social media platform relevant to an enterprise, and generating a response to the customer post using information obtained from a enterprise's site-level corpus.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for responding to a social media query with a response generated from a site-level corpus, the method comprising:
capturing, by a processor, a query transmitted to a social media stream associated with an enterprise;
transmitting the query to a site-level search engine associated with the enterprise;
identifying an appropriate response to the transmitted query based on one or more results from the site-level search engine;
generating a social media response to the captured query using one or more natural language processing techniques; and
transmitting the generated social media response to the social media stream.

2. The method of claim 1, wherein identifying the appropriate response is further based on natural language processing and semantic intent.

3. The method of claim 1, wherein identifying the appropriate response is further based on a response selection criteria selected from a group consisting of a first response returned from a search query and a first response returned with similar semantic intent.

4. The method of claim 1, wherein further comprising:
presenting the generated social media response to a user for approval prior to transmitting the generated social media response to the social media stream.

5. The method of claim 4, further comprising:
calculating a confidence score for the generated social media response using one or more natural language processing techniques, wherein transmitting the generated social media response to the social media stream, without user approval of the generated social media response, is based on the calculated confidence score satisfying a confidence threshold value, and wherein presenting the generated social media response to a user for approval prior to transmitting the generated social media response to the social media stream is further based on the calculated confidence score not satisfying a confidence score threshold.

6. The method of claim 1, wherein, the captured query is a message sent to an enterprise on a social media network.

7. The method of claim 1, wherein generating the social media response further comprises utilizing one or more additional cognitive factors selected from a group consisting of sentiment analysis, semantic intent, tone analysis, and a plurality of personalized information.

8. A computer system for responding to a social media query with a response generated from a site-level corpus, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
capturing a query transmitted to a social media stream associated with an enterprise;
transmitting the query to a site-level search engine associated with the enterprise;
identifying an appropriate response to the transmitted query based on one or more results from the site-level search engine;
generating a social media response to the captured query using one or more natural language processing techniques; and
transmitting the generated social media response to the social media stream.

9. The computer system of claim 8, wherein identifying the appropriate response is further based on natural language processing and semantic intent.

10. The computer system of claim 8, wherein identifying the appropriate response is further based on a response selection criteria selected from a group consisting of a first response returned from a search query and a first response returned with similar semantic intent.

11. The computer system of claim 8, wherein further comprising:
presenting the generated social media response to a user for approval prior to transmitting the generated social media response to the social media stream.

12. The computer system of claim 11, further comprising:
calculating a confidence score for the generated social media response using one or more natural language processing techniques, wherein transmitting the generated social media response to the social media stream, without user approval of the generated social media response, is based on the calculated confidence score satisfying a confidence threshold value, and wherein presenting the generated social media response to a user for approval prior to transmitting the generated social media response to the social media stream is further based on the calculated confidence score not satisfying a confidence score threshold.

13. The computer system of claim 8, wherein, the captured query is a message sent to an enterprise on a social media network.

14. The computer system of claim 8, wherein generating the social media response further comprises utilizing one or more additional cognitive factors selected from a group consisting of sentiment analysis, semantic intent, tone analysis, and a plurality of personalized information.

15. A computer program product for responding to a social media query with a response generated from a site-level corpus, the computer program product comprising:
one or more computer-readable tangible storage media and program instructions stored on at least one of the one or more tangible storage media, the program instructions executable by a processor of a computer to perform a method, the method comprising:
capturing a query transmitted to a social media stream associated with an enterprise;
transmitting the query to a site-level search engine associated with the enterprise;
identifying an appropriate response to the transmitted query based on one or more results from the site-level search engine;
generating a social media response to the captured query using one or more natural language processing techniques; and
transmitting the generated social media response to the social media stream.

16. The computer program product of claim 15, wherein identifying the appropriate response is further based on natural language processing and semantic intent.

17. The computer program product of claim 15, wherein identifying the appropriate response is further based on a response selection criteria selected from a group consisting of a first response returned from a search query and a first response returned with similar semantic intent.

18. The computer program product of claim 15, wherein further comprising:
presenting the generated social media response to a user for approval prior to transmitting the generated social media response to the social media stream.

19. The computer program product of claim 18, further comprising:
calculating a confidence score for the generated social media response using one or more natural language processing techniques, wherein transmitting the generated social media response to the social media stream, without user approval of the generated social media response, is based on the calculated confidence score satisfying a confidence threshold value, and wherein presenting the generated social media response to a user for approval prior to transmitting the generated social media response to the social media stream is further based on the calculated confidence score not satisfying a confidence score threshold.

20. The computer program product of claim 15, wherein, the captured query is a message sent to an enterprise on a social media network.
